(19) United States
(12) Patent Application Publication
(10) Pub. No.: US 2025/0051515 A1
(43) Pub. Date: Feb. 13, 2025

(54) PROCESS FOR THE PRODUCTION OF POLYESTER (CO)POLYMERS

(71) Applicant: Avantium Knowledge Centre B.V., Amsterdam (NL)

(72) Inventors: Bing WANG, Amsterdam (NL); Gerardus Johannes Maria Gruter, Amsterdam (NL); Robert-Jan VAN PUTTEN, Amsterdam (NL); Daniel Herbert WEINLAND, Amsterdam (NL); Bruno BOTTEGA PERGHER, Amsterdam (NL)

(21) Appl. No.: 18/722,954

(22) PCT Filed: Dec. 22, 2022
(86) PCT No.: PCT/EP2022/087423

§ 371 Date: Jun. 21, 2024

(30) Foreign Application Priority Data
Dec. 24, 2021 (EP) 21217721.6

(51) Int. Cl. C08G 63/81; C08G 63/183; C08G 63/50; C08G 63/672; C08G 63/688

(52) U.S. Cl. CPC C08G 63/81; C08G 63/183; C08G 63/50; C08G 63/672; C08G 63/6886

(57) ABSTRACT

The invention relates to a process for the chemical production of a polyester (co)polymer starting from monomers and/or oligomers, comprising reacting a mixture of at least (a) one or more diol monomers, and (b) one or more dicarboxylic acid monomers and/or esters thereof, and/or one or more oligomers comprising monomer units of (a) and (b); wherein at least one diol monomer (a) is a secondary diol monomer; and wherein in the process also is added (c) a monohydric alcohol with a boiling point at ambient pressure of equal to or higher than 175° C. and an acid dissociation constant determined at 25° C. in water of equal to or less than 12.0 and equal to or more than 7.0, in an amount of 2.5-100 weight % with regard to the total weight of monomers and/or oligomers.

### FIELD OF THE INVENTION

The invention relates to a process for the chemical production of a polyester (co)polymer comprising reacting a mixture of at least one or more secondary diols and one or more dicarboxylic acids and/or esters thereof, a novel polyester (co)polymer obtainable by said method, a composition comprising said novel polyester (co)polymer and an article comprising said polyester (co)polymer.

### BACKGROUND OF THE INVENTION

Polyethyleneterephthalate (PET) is an important polyester material and currently is the second largest in volume of the ‘big 5’ plastics, with a global annual production of around 80 million tons [www.textileworld.com/textile-world/features/2019/07/challenges-facing-recycled-polyester/]. The most common PET applications are fibres (textiles; 56 million tons/yr) and single-use packaging such as bottles (20 million tons/yr), engineering plastics and films. Although PET has a lot of favourable properties, an important disadvantage of the material is that is not biodegradable, whereas recycling of PET is still only done with only about 3% of all PET that is used worldwide. Therefore, research to develop new classes of polyesters has been initiated, and has already resulted in the discovery of other monomers that can be used in the production of new (co)polymers.

For instance, it was found that many monomers useful in today's fossil-based plastics can likely be synthesized from biobased feedstocks. One example of this is 2,5-furandicarboxylic acid (FDCA), which has been identified as a biobased alternative to terephthalic acid (TPA), which is used to produce PET. Poly(ethylene-2,5-furanoate) (PEF), a fully biobased polyester when prepared from biobased FDCA and biobased ethyleneglycol, shows superior thermal, barrier and mechanical properties compared to fossil-based PET.

Other interesting monomers are for example diol monomers, such as 1,4:3,6-dianhydrohexitols, which are a class of rigid diol monomers derived from D-glucose, D-mannose or D-idose. The monomers can be obtained after reduction of the respective sugar to the corresponding sugar alcohol and two subsequent dehydration reactions. Isosorbide is the most widely available 1,4:3,6-dianhydrohexitol due to it being derived from the sugar alcohol sorbitol.

For example, WO 2018/211133 describes a process for the production of an isosorbide (or related) polyester copolymer comprising polymerizing the following monomers: (i) in the range from equal to or more than 25 mole % to equal to or less than 49.9 mole %, based on the total amount of moles of monomers, of one or more bicyclic diols chosen from the group consisting of isosorbide, isoidide, isomannide, 2,3:4,5-di-O-methylene-galactitol and 2,4:3,5-di-O-methylene-D-mannitol; (ii) in the range from equal to or more than 45 mole % to equal to or less than 50 mole %, based on the total amount of moles of monomers, of one or more oxalic diesters having a chemical structure according to formula (VI): R₂—OC(O)—C(O)—OR₃ (VI), wherein R₂ and R₃ each independently are a C3-C20 alkyl group, a C2-C20 alkenyl group, a C4-C20 cycloalkyl group, a C4-C20 aryl group or a C5-C20 alkylarylgroup; (iii) in the range from equal to or more than 0.1 mole % to equal to or less than 25 mole %, based on the total amount of moles of monomers, of one or more linear C2-C12 diols; and (iv) optionally equal to or more than 0 mole % to equal to or less than 5 mole %, based on the total amount of moles of monomers, of one or more additional monomers.

Isosorbide is applied in polyesters, for example for increasing the glass transition temperature and for reducing the melting temperature compared to the parent polymer, as the bent structure of isosorbide weakens interactions between polymer chains. An example of a polymer in which isosorbide can be incorporated is the polyester poly(1,4-cyclohexanedimethylene terephthalate) (PCT), which possesses excellent mechanical properties due to its rigid structure. The main drawback of this polyester is, however, the high melting temperature of 278-318° C., which is close to the polymer's decomposition temperature. This results in difficult processing of the polyester, as thermal degradation can result in brittleness of the final material. The incorporation of isosorbide into the PCT polyester was investigated. The problem with isosorbide is that it carries two secondary alcohol functionalities, that generally react only very slowly, especially when compared to highly reactive primary alcohol functionalities, such as present in for example ethylene glycol or the above mentioned cyclohexane dimethanol. As a consequence, until now it has proven very difficult to produce high molecular weight copolymers with high isosorbide content.

It would be advantageous to provide an efficient process to chemically produce copolymers with a high content of, preferably sustainable, monomers derived from secondary diols, in particular (bi)cyclic secondary diols, and especially isosorbide, wherein (new) high molecular weight copolyesters are produced. Particularly interesting would be new copolyesters with improved properties, such as improved mechanical, thermal, gas barrier, and/or caustic resistance and/or biodegradability properties compared to currently known polyesters. Further, it would be an advancement to be able to produce a huge variety of polyester copolymers with tunable properties, which may be suitable for specific targeted applications.

### SUMMARY OF THE INVENTION

Accordingly, the present invention provides a process for the chemical production of a polyester (co)polymer starting from monomers and/or oligomers, comprising reacting a mixture of at least (a) one or more diol monomers, and (b) one or more dicarboxylic acid monomers and/or esters thereof, and/or one or more oligomers comprising monomer units of (a) and (b); wherein at least one diol monomer, and in particular at least 5 mole % of the diol monomers, more preferably at least 10 mole % of the diol monomers, (a) is a secondary diol monomer; and wherein in the process also is added (c) a monohydric alcohol with a boiling point at ambient pressure of equal to or higher than 175° C. and an acid dissociation constant determined at 25° C. in water of equal to or less than 12.0 and equal to or more than 7.0, in an amount of 2.5-100 weight % with regard to the total weight of monomers and/or oligomers.

Advantageously, the process allows more complete conversion of the secondary diol, and therefore less excess thereof is needed in the feed. By using limited amounts of the monohydric alcohol (c), it is possible to produce a high molecular weight polyester (co)polymer that comprises significant quantities of monomer units derived from said secondary diols, in particular in case said diol is a (bi)cyclic secondary diol. The process of the invention opens possibilities for the convenient production of copolymers comprising increased amounts of monomer units derived from rigid sterically constrained (bi)cyclic secondary diols. Especially, when said secondary diol is isosorbide, surprisingly high content of the isosorbide-derived monomer may be found in the polyester (co)polymer product.

Accordingly, the process of the present invention allows for the preparation of polyester (co)polymers with tunable properties comprising monomer units derived from renewable materials, while obtaining high number average molecular weights of the polyester end product.

The present invention provides an advantageous process for the preparation of both existing and, in particular, novel polyester (co)polymers. Said polyester (co)polymers according to the invention can advantageously be used in a broad range of (industrial) applications, such as in films, fibres, injection (blow) moulded parts and bottles and packaging materials.

In addition, the invention provides a composition comprising any one of said novel polyester (co)polymers and in addition one or more additives and/or one or more additional polymers.

Further, the invention provides an article comprising the polyester (co)polymer according to the present invention or a composition comprising said polyester (co)polymer and one or more additives and/or additional (co)polymers.

### DETAILED DESCRIPTION OF THE INVENTION

The present invention relates to a polymerization process for the production of a polyester copolymer. By a “polyester” herein is understood a polymer comprising a plurality of monomer units linked via ester functional groups in its main chain. An ester functional group can be formed by reacting a hydroxyl group (—OH) with a carboxyl/carboxylic acid group (—C(═O)OH). Typically, a polyester is a synthetic polymer formed by the reaction of one or more bifunctional carboxylic acids with one or more bifunctional hydroxyl compounds. By a “polyester copolymer” is herein understood a polyester wherein three or more types of monomer units are joined in the same polymer main chain.

By a “monomer unit” is herein understood a unit as included in a polyester copolymer or oligomer, which unit can be obtained after polymerization of a monomer, that is, a “monomer unit” is a constitutional unit contributed by a single monomer or monomer compound to the structure of the polymer or oligomer, herein in particular the smallest diol or di-acid repeating unit.

By a “monomer” or “monomer compound” is herein understood the smallest diol or di-acid compound used as the starting compound to be polymerized.

By an “oligomer” or “oligomer compound” is herein understood a molecular structure comprising an in total average number of monomer units of in the range from equal to or more than 2 to equal to or less than 9 monomer units, and preferably in the range from equal to or more than 3 to equal to or less than 5 monomer units. Next to diol and di-acid derived monomer units, also other monomer units may be part of the oligomer, such as hydroxycarboxylic acid derived monomer units, in particular derived from α-hydroxycarboxylic acids, such as glycolic acid, lactic acid, mandelic acid, and the like. The average molecular weight (Mn) of the oligomer may be equal to or more than 300 grams/mole up to 1750 grams/mole.

In the process of the invention, at least a secondary diol is used. Such secondary diol may be selected from cyclic or non-cyclic, preferably aliphatic, diols. Preferred examples of non-cyclic aliphatic diols are vicinally substituted diols, such as 2,3-butanediol. Preferably, at least one secondary diol (a) is/are selected from cyclic or bicyclic secondary diols, and in particular from 1,4:3,6-dianhydrohexitols, cis- and/or trans-2,2,4,4-tetramethyl-1,3-cyclobutanediol, especially from 1,4:3,6-dianhydrohexitols, and preferably from isosorbide and/or isoidide, and in particular one secondary diol is isosorbide. In preferred embodiments, isosorbide is the only secondary diol used in the process. The group of 1,4:3,6-dianhydrohexitols consists of isosorbide (1,4:3,6-dianhydro-D-sorbitol), isoidide (1,4:3,6-dianhydro-L-iditol) and isomannide (1,4:3,6-dianhydro-D-mannitol).

The most significant difference among the class of 1,4:3,6-dianhydrohexitol isomers may be the orientation of the two hydroxyl groups. This difference in orientation will result in different orientations of the ester group in the polymer, allowing for several variations in spatial configuration and physical and chemical properties of the polymer. According to the process of the present invention, it is possible for the polyester (co)polymer to comprise only one isomer of 1,4:3,6-dianhydrohexitol-derived monomer units or to comprise a mixture of two or more isomers of 1,4:3,6-dianhydrohexitol-derived monomer units, for example a mixture of monomer units derived from isosorbide and/or isomannide and/or isoidide.

According to the process of the invention, at least one of the one or more secondary diols (a) is/are selected from cyclic or bicyclic secondary diols, and in addition also other diols may be used. A large range of diols may be selected, depending on the desired properties of the produced polyester copolymer. The type and amounts of the different monomer units in the copolymer may for instance impact the thermal properties and the crystallinity, but also barrier, mechanical and other properties. For example, the glass transition temperature Tg of the produced polyester copolymer may be targeted to a desired value by tuning the amount of the different monomer units.

Thus, conveniently several properties, like the Tg, of the produced polyester copolymer can be targeted to a desired value by tuning selection of the type and amount of diols during the process, but also by tuning selection of the type and amount of the one or more dicarboxylic acids or any esters thereof (b). According to the process of this disclosure, polyester copolymers with a commercially interesting number average molecular weight may be obtained within commercially advantageous reaction times.

As stated above, amongst others, the selection of the type and amount of the diols in the process influences the eventual Tg. When high Tg's (specifically higher than 80° C., more preferably equal to or higher than 100° C., in particular up to and including 160° C. but for selected uses also up to 210° C. is possible) are targeted, in addition to the secondary diol monomers (a), at least one further diol is added, selected from C2-C18 aliphatic diols, in particular from linear, cyclic or branched, saturated C2-C12 aliphatic diol compounds, and preferably from ethylene glycol, 1,3-propanediol, 1,4-butanediol, 1,5-pentanediol, 1,6-hexanediol, diethyleneglycol, neopentylglycol, 1,4-cyclohexanedimethanol, and acetals of polyols, especially acetals of C6 polyols, and particularly 2,3:4,5-di-O-methylene-galactitol, 2,4:3,5-di-O-methylene-D-mannitol, 2,4:3,5-di-O-methylene-D-glucitol, 2,3:4,5-di-O-isopropylidene-galactitol, 2,4:3,5-di-O-isopropylidene-D-mannitol and 2,4:3,5-di-O-isopropylidene-D-glucitol. In particular, 1,4-cyclohexanedimethanol and 1,3-propanediol are each a preferred further diol for improving impact strength of the polyester copolymer.

According to the presently claimed process, at least one (bi)cyclic secondary diol is used to produce a polyester copolymer comprising monomer units derived from said (bi)cyclic secondary diol in sufficient amounts to confer certain relevant properties. Especially when high Tg's are targeted, preferably the polyester copolymer generated by the process comprises monomer units derived from said (bi)cyclic secondary diol in at least 10 mole %, preferably 20-30 mole %, suitably 30-40 mole %, up to 60 mole %, for selected applications even up to 100 mole %, the percentage based on the total amount of diol-derived monomer units in polyester copolymer. Preferably, said diol-derived monomer units are 1,4:3,6-dianhydrohexitol-derived monomer units.

As said, also the type and amount of the (b) one or more dicarboxylic acids and/or any esters thereof will have a tuning effect on the properties of the produced polyester (co)polymer. In the current process, the one or more dicarboxylic acid monomers and/or esters thereof (b) is/are selected from (hetero)aromatic dicarboxylic acids (i.e. heteroaromatic dicarboxylic acids and aromatic dicarboxylic acids), and from C2-C18 aliphatic dicarboxylic acids which may be linear, cyclic or branched, and/or monoesters and/or diesters thereof.

When more rigidity is desired, the one or more dicarboxylic acid monomers and/or esters thereof (b) is/are selected from terephthalic acid, a terephthalic acid monoester, a terephthalic acid diester, a furandicarboxylic acid, a furandicarboxylic acid monoester, and a furandicarboxylic acid diester (in particular 2,5-furandicarboxylic acid and/or mono/diester thereof).

If more flexible (co)polymers are desired, the one or more dicarboxylic acid monomers and/or esters thereof (b) is/are selected from aliphatic dicarboxylic acids, preferably from 1,4-cyclohexanedicarboxylic acid, diglycolic acid, and linear dicarboxylic acids of the formula HOOC(CH₂)ₙCOOH wherein n is an integer of 0 to 20, and/or esters thereof. Preferred linear dicarboxylic acids and/or esters thereof are oxalic acid esters, succinic acid, adipic acid, and/or esters thereof, and especially succinic acid is preferred.

In a preferred embodiment of process of the invention, the total amount of diols of the one or more secondary diol monomer(s) (a) and any optional further diol, and the total amount of the one or more dicarboxylic acid monomer(s) and/or any esters thereof (b) are used in the process in a molar ratio of the total sum of diols to the total sum of dicarboxylic acids or any esters thereof of 1.5:1.0 to 1.0:1.0, and wherein in case a rigid polymer is targeted, preferably the only secondary diol (a) is isosorbide, the only further diol is selected from ethylene glycol, 1,4-cyclohexanedimethanol and 1,3-propanediol, and the one or more dicarboxylic acids or any esters thereof (b) is terephthalic acid and/or furan dicarboxylic acid. In case a flexible polymer is targeted, preferably the only secondary diol (a) is isosorbide, a further diol needs to be present and is selected from ethylene glycol, 1,4-cyclohexanedimethanol, 1,3-propanediol and 1,6-hexanediol, and the one or more dicarboxylic acids or any esters thereof (b) is succinic acid.

When the properties of the polyester copolymer are targeted towards a (relatively) high glass transition temperature in the range from equal to or higher than 80° C. to less than 160° C., preferably equal to or less than 140° C., the polyester (co)polymer can be very suitable for use in applications where a product, such as for example a film, fibre, injection moulded part or packaging material, needs to be heat-resistant, for example in the case of coffee cups, microwave applications and certain medical applications. Also, (co)polymers for ABS replacement may be targeted. On the other hand, when the polyester copolymer is targeted towards a medium glass transition temperature in the range from equal to or more than 60° C. to equal to or less than 100° C., the polyester copolymer can be very suitable for use in applications where a product needs to remain resilient at low temperatures and/or needs to be able to withstand cold without breaking or becoming too brittle, for example in the case of outdoor furniture. When the polyester copolymer is targeted towards a glass transition temperature in the range from equal to or more than 60° C. to equal to or less than 120° C. or equal to or less than 100° C., the polyester copolymer can be very suitable for the replacement of poly(ethylene terephthalate) (PET) in applications such as bottles and/or containers.

The process of the invention advantageously comprises adding a monohydric alcohol in the process, which has a facilitating effect in the process to produce high molecular weight polyester (co)polymers. This is an unexpected effect, as for example mono-alcohols are known to be “terminators” in certain polymerization reactions, sealing the ends of growing polymeric chains. The monohydric alcohol may be added already at the start of the esterification reaction, surprisingly without detrimental effect on the molecular weight. The contrary is observed, as even higher molecular weights may be obtained than when the polymerization is performed in the absence of the monohydric alcohol. Favorably, the process may be performed in the presence of the monohydric alcohol starting with reacting the diol monomers (a) with dicarboxylic acid monomers (b) without necessarily having to first convert those dicarboxylic acid monomers into corresponding diesters. Even in the presence of the monohydric alcohol and while water is being formed in the esterification reaction, the polymerization process of the invention results in high molecular weight polyester (co)polymers.

Advantageously, the addition of the monohydric alcohol in the present process removes the necessity of first producing diaryl esters of the dicarboxylic acids and subsequent purification, as commonly applied in esterification reactions, thereby reducing the number of process steps by two and thus significantly reducing complexity and costs of the process.

In the monohydric alcohol the hydroxy group is the only reactive functional group, and further the alcohol has a boiling point at ambient pressure of equal to or higher than 175° C. up to equal to or lower than 300° C. and an acid dissociation constant (pKa) of equal to or less than 12.0 and equal to or more than 7.0 (as known from literature, determined at 25° C. in water). The amount of the alcohol used is 2.5-100 weight % with regard to the total weight of monomers and/or oligomers, preferably 5 to 95 weight %, more preferably 10 to 90 weight %, and particularly 20 to 80 weight %, and especially 30 to 70 weight %. In particular, the alcohol (c) is an optionally substituted phenol, in particular selected from phenol, 4-methylphenol, 4-ethylphenol, 2-methoxyphenol, 4-methoxyphenol, 4-ethyl-2-methoxyphenol, 4-chlorophenol, and any combination thereof. The monohydric alcohol may be added at multiple stages of the process. Suitably, the total amount of the monohydric alcohol (c) is as added at the start of the reaction. The addition of the monohydric alcohol may take place before the reaction starts, e.g. preferably by first mixing the monomer(s) with the alcohol. Also, the alcohol may be added in a later stage during the reaction, or both at the start and during the reaction, whenever required. In an embodiment, some of the alcohol (c) is added to the process as from the start of the process and, in addition, more of the alcohol (c) is continuously supplied to the reaction mixture during the process. Preferably, the alcohol is added before or during the esterification step. The monohydric alcohol may serve as a reactive diluent in the reaction mixture, which may be desirable or considered necessary under certain circumstances. If deemed suitable, in addition to the monohydric alcohol, also an inert solvent, in particular diphenyl ether, dimethoxybenzene, etc., may be added to the reaction.

Advantageously, when using monohydric alcohol in the presently claimed process, and when compared to polymerization techniques known in the art which start from a mixture of monomers, less of the isosorbide is lost during polymerization, and more isosorbide is incorporated in the resulting polyester copolymer.

As the process of the invention proceeds, the monohydric alcohol(s) present in the reaction mixture, is/are released from the reactor. The released materials can advantageously be separated and purified to be recycled. Therefore, another embodiment of the invention relates to the above described polymerization process, comprising in addition, separating the monohydric alcohol and the optionally present water (e.g. by distillation), optionally followed by purifying the separated materials to recover the purified monohydric alcohol, and preferably recycling said purified monohydric alcohol into the process.

Preferably, the diols and/or dicarboxylic acids used in the current process are obtained and/or derived from a renewable source, e.g. sustainable biomass material. By a biomass material is herein understood a composition of matter obtained and/or derived from a biological source as opposed to a composition of matter obtained and/or derived from petroleum, natural gas or coal. The biomass material can for example be a polysaccharide, such as starch, or a cellulosic and/or lignocellulosic material. By sustainable is herein understood that the material is harvested and/or obtained in a manner such that the environment is not depleted or permanently damaged. Sustainable biomass material may for example be sourced from forest waste, agricultural waste, waste paper and/or sugar processing residues. Isosorbide, isomannide and isoidide can be suitably obtained by dehydrating respectively sorbitol, mannitol and iditol. The synthesis of these 1,4:3,6-dianhydrohexitols per se is well known in the art.

The amounts of each of the different monomeric units in the polyester copolymer often can be determined by proton nuclear magnetic resonance (¹H NMR). One skilled in the art would easily find the conditions of analysis to determine the amount of each of the different monomer units in the polyester copolymer. Other analysis methods can include depolymerization, followed by monomer quantification (versus standards). Polyesters can be depolymerized in water (hydrolysis), in alcohol, e.g. methanol (alcoholysis, e.g. methanolysis) or in glycol (glycolysis). An excess of depolymerization solvent ensures full depolymerization and a catalyst (e.g. a base) can accelerate the depolymerization.

The polyester copolymer(s) according to the invention can be a random copolymer or can have a more blocky microstructure.

The number average molecular weight (Mn) of the polyester copolymer(s) may vary and may depend for example on the added monomer type and amount, the catalyst, the reaction time and reaction temperature and pressure. Advantageously, the number average molecular weight of the polyester copolymer(s) according to the invention is at least 15000 grams/mole and preferably the number average molecular weight is equal to or more than 16500 grams/mole, particularly equal to or more than 18000 grams/mole, more preferably of equal to or more than 20000 grams/mole up to as high as 100000 grams/mole.

The weight average molecular weight (Mw) and the number average molecular weight (Mn) can be determined by means of gel permeation chromatography (GPC) at 35° C., using for the calculation poly(methyl methacrylate) (PMMA) or polystyrene (PS) standards as reference material, and using hexafluoro-2-propanol or dichloromethane, respectively, as eluent. The combination of PMMA with hexafluoro-2-propanol is used when aromatic diacid or heteroaromatic diacid derived monomer units are present in the (co)polymer, and the combination PS and dichloromethane is used when aliphatic diacid monomer units are present in the (co)polymer. All molecular weights herein are determined as described under the analytical methods section of the examples.

Suitably the polyester copolymer according to the present invention may have a polydispersity index (that is, the ratio of weight average molecular weight (Mw) to number average molecular weight (Mn), i.e. Mw/Mn) in the range from equal to or higher than 1.6 to equal to or lower than 2.8, in particular from equal to or higher than 1.8 to equal to or lower than 2.6.

The glass transition temperature of the polyester copolymer can be measured by conventional methods, in particular by using differential scanning calorimetry (DSC) with a heating rate of 10° C./minute in a nitrogen atmosphere. All glass transition temperatures herein are determined as described under the analytical methods section of the examples.

The process according to the invention may comprise several stages. Suitably the process according to the invention comprises an esterification/transesterification stage and a polycondensation stage, wherein the esterification/transesterification stage is carried out prior to the polycondensation stage. The esterification/transesterification stage may suitably be preceded by an introduction stage, comprising introducing the suitable monomers into a reactor. During the esterification/transesterification reaction, condensation products, such as water, may be distilled off. The polycondensation stage may suitably be succeeded by a recovery stage, wherein the polyester copolymer is recovered from a reactor.

The process according to the invention can be carried out in a batch-wise, semi-batchwise or continuous mode. The esterification/transesterification stage and the polycondensation stage may conveniently be carried out in one and the same reactor, but may also be carried out in two separate reactors, for example where the esterification/transesterification stage is carried out in a first esterification/transesterification reactor and the polycondensation stage is carried out in a second polycondensation reactor.

In any introduction stage the monomers may be introduced into the reactor simultaneously, for example in the form of a feed mixture, or in separate parts. The monomers may be introduced into the reactor in a molten phase or they can be molten and mixed after introduction into the reactor.

Any transesterification stage is preferably carried out in a reaction time in the range from equal to or more than 0.5 hour, more preferably equal to or more than 1.0 hour, to equal to or less than 20.0 hour, preferably to equal to or less than 10 hours, more preferably equal to or less than 6.0 hour. During a transesterification stage, the temperature may be stepwise or gradually increased.

Any polycondensation stage is preferably carried out in a reaction time in the range from equal to or more than 0.5 hour, more preferably equal to or more than 1.0 hour, to equal to or less than 8.0 hours, more preferably equal to or less than 6.0 hours. During a polycondensation stage, the temperature may be stepwise or gradually increased.

The polycondensation stage may suitably be carried out at a temperature equal to or higher or a bit lower than the temperature at which the transesterification stage is carried out depending on the polymers. The transesterification stage may for example be carried out at a temperature in the range from equal to or higher than 170° C., and depending on the desired polymer (e.g. high Tg polymers) preferably equal to or higher than 210° C., and even more preferably equal to or higher than 230° C., to equal to or lower than 260° C. The poly-condensation stage may suitably succeed the transesterification stage and the poly-condensation stage can for example be carried out at a temperature in the range from equal to or higher than 220° C., and depending on the desired polymer (e.g. high Tg polymers) more preferably equal to or higher than 265° C., to equal to or lower than 300° C., more preferably equal to or lower than 285° C. and most preferably equal to or lower than 275° C.

The polycondensation stage may be succeeded by a recovery stage, wherein the polyester copolymer as described above is recovered from the reactor. The polyester can for example be recovered by extracting it from the reactor in the form of a string of molten polymer. This string can be converted into granules using conventional granulation techniques.

The esterification/transesterification stage is preferably carried out under an inert gas atmosphere, suitably at ambient pressure or slightly above that, e.g. up to 5 bar. Preferably, the polycondensation stage is carried out at reduced pressure.

A suitable and advantageous way to perform the process of the invention comprises the following steps: (i) in a reaction vessel heating a mixture of the diol monomer(s), the dicarboxylic acid monomer(s) and/or any esters thereof and the monohydric alcohol to a certain temperature for a certain period of time until a clear melt is obtained; (ii) continuing the esterification/transesterification reaction (under stirring) at elevated temperature while removing condensation products (specifically water) at a pressure of 1 to 5 bar; (iii) reducing the pressure in the vessel of step (ii) to a vacuum of lower than 20 mbar, preferably lower than 10 mbar, more preferably lower than 5 mbar, and particularly lower than 1 mbar, with continued stirring for a certain period of time; and optionally during step (iii) further increasing the temperature by 10 to 50° C.—to facilitate removal of the monohydric alcohol and the remaining condensation products from the reactor The process according to the invention may be carried out in the presence of one or more additives, such as stabilizers, for example light stabilizers, UV stabilizers and heat stabilizers, fluidifying agents, flame retardants, ether formation suppressants and antistatic agents. Phosphoric acid is an example of a stabilizer applied in PET. Additives may be added at the start of the process, or during or after the polymerization reaction. Other additives include primary and/or secondary antioxidants. A primary antioxidant can for example be a sterically hindered phenol, such as the compounds Hostanox® 0 3, Hostanox® 0 10, Hostanox® 0 16, Ultranox® 210, Ultranox® 276, Dovernox® 10, Dovernox® 76, Dovernox® 3114, Irganox®1010 or Irganox®1076. A secondary antioxidant can for example be a trivalent phosphorous-comprising compounds, such as Ultranox® 626, Doverphos® S-9228 or Sandostab® P-EPQ.

The process according to the invention is suitably carried out in the presence of a catalyst, preferably of a metal-containing catalyst. The catalyst preferably is used in amounts from 0.01 mole % to 0.5 mole % with regard to the total amount of monomers (in moles). Such metal-containing catalyst may for example comprise derivatives of tin (Sn), titanium (Ti), zirconium (Zr), germanium (Ge), antimony (Sb), bismuth (Bi), hafnium (Hf), magnesium (Mg), cerium (Ce), zinc (Zn), cobalt (Co), iron (Fe), manganese (Mn), calcium (Ca), strontium (Sr), sodium (Na), lead (Pb), potassium (K), aluminium (Al), and/or lithium (Li). Examples of suitable metal-containing catalysts include salts of Li, Ca, Mg, Mn, Zn, Pb, Sb, Sn, Ge, and Ti, such as acetate salts and oxides, including glycol adducts, and Ti alkoxides. Examples of such compounds can, for example, be those given in US2011282020A1 in sections [0026] to [0029], and on page 5 of WO 2013/062408 A1. Preferably the metal-containing catalyst is a tin-containing catalyst, for example a tin(IV)- or tin(II)-containing catalyst. More preferably the metal-containing catalyst is an alkyltin(IV) salt and/or alkyltin(II) salt. Examples include alkyltin(IV) salts, alkyltin(II) salts, dialkyltin(IV) salts, dialkyltin(II) salts, trialkyltin(IV) salts, trialkyltin(II) salts or a mixture of one or more of these. These tin(IV) and/or tin(II) catalysts may be used with alternative or additional metal-containing catalysts. Examples of alternative or additional metal-containing catalysts that may be used include one or more of titanium(IV) alkoxides or titanium(IV) chelates, zirconium(IV) chelates, or zirconium(IV) salts (e.g. alkoxides); hafnium(IV) chelates or hafnium(IV) salts (e.g. alkoxides); yttrium(III) alkoxides or yttrium(III) chelates; lanthanum(III) alkoxides or lanthanum chelates; scandium(III) alkoxides or chelates; cerium(III) alkoxides or cerium chelates. An exemplary metal-containing catalyst is n-butyltinhydroxide oxide.

The process according to the invention may optionally further comprise, in case the polymer is semi-crystalline, after a recovery stage (i.e. wherein the polyester (co)polymer is recovered from the reactor) as described above, a stage of polymerization in the solid state. That is, the polyester (co)polymer recovered as described above may be polymerized further in the solid state, thereby increasing chain length. Such polymerization in the solid state is also referred to as a solid state polymerization (SSP). Such a solid state polymerization advantageously allows one to further increase the number average molecular weight of the polyester (co)polymer. If applicable, SSP can further advantageously enhance the mechanical and rheological properties of polyester copolymers before injection blow molding or extruding. The solid state polymerization process preferably comprises heating the polyester (co)polymer in the essential or complete absence of oxygen and water, for example by means of a vacuum or purging with an inert gas.

Advantageously the process according to the invention can therefore comprise:
a melt polymerization wherein the above described (co)polymers are polymerized in a melt to produce a polyester copolymer melt product;
an optional pelletisation wherein the polyester copolymer melt product is converted into pellets, and the optional drying of the pellets under vacuum or with the help of inert gas purging;
an optional solid state polymerization of the polyester copolymer melt product, optionally in the form of pellets, at a temperature above the Tg of the polyester copolymer melt product and below the melt temperature of the polyester copolymer melt product.

Generally, solid state polymerization may suitably be carried out at a temperature in the range from equal to or more than 150° C. to equal to or less than 220° C. The solid state polymerization may suitably be carried out at ambient pressure (i.e. 1.0 bar atmosphere corresponding to 0.1 MegaPascal) whilst purging with a flow of an inert gas (such as for example nitrogen or argon) or may be carried out at a vacuum, for example a pressure equal to or below 100 millibar (corresponding to 0.01 MegaPascal). The solid state polymerization may suitably be carried out for a period up to 120 hours, more suitably for a period in the range from equal to or more than 2 hours to equal to or less than 60 hours. The duration of the solid state polymerization may be tuned such that a desired final number average molecular weight for the polyester copolymer is reached.

In a further embodiment, the present invention provides a polyester (co)polymer obtainable by, or in particular obtained by, a process according to the invention, in particular a polyester (co)polymer, having a number average molecular weight, as measured by gel permeation chromatography, of 15000 daltons or more, in particular 16500 daltons or more, more particular 18000 daltons or more, and especially 20000 daltons or more, having a polydispersity index of from equal to or higher than 1.8 to equal to or lower than 2.8, more particular to equal to or lower than 2.6, and particularly containing or consisting of repeating units selected from one or more of isosorbide-succinate, isosorbide-glutarate, isosorbide-adipate, isosorbide-diglycolate, isosorbide-thiodiglycolate, isosorbide-1,4-cyclohexane-dicarboxylate, isomannide-succinate, isomannide-glutarate, isomannide-adipate, isomannide-diglycolate, isomannide-thiodiglycolate, isomannide-1,4-cyclohexanedicarboxylate, isosorbide-co-1,4-cyclohexanedimethylene furanoate, isosorbide-co-1,3-propylene terephthalate, isosorbide-co-1,3-propylene furanoate and isosorbide succinate-co-terephthalate, and a polyester (co)polymer having a number average molecular weight Mn, as measured by gel permeation chromatography, of preferably 22000 daltons or more, containing or consisting of repeating units of isosorbide-co-1,4-cyclohexanedimethylene terephthalate.

Especially, said polyester (co)polymer is a polyester (co)polymer comprising total dicarboxylic acid-derived monomer units and total diol-derived monomer units in a 1:1 ratio, selected from
poly(isosorbide-succinate), especially having a Mn of 30000 daltons or higher;
poly(isosorbide-glutarate), especially having a Mn of 35000 daltons or higher;
poly(isosorbide-adipate), especially having a Mn of 27000 daltons or higher;
poly(isosorbide-diglycolate), especially having a Mn of 20000 daltons or higher;
poly(isosorbide-thiodiglycolate), especially having a Mn of 15000 daltons or higher;
poly(isosorbide-1,4-cyclohexanedicarboxylate), especially having a Mn of 35000 daltons or higher;
poly(isomannide-succinate), especially having a Mn of 23000 daltons or higher;
poly(isomannide-glutarate), especially having a Mn of 35000 daltons or higher;
poly(isomannide-adipate), especially having a Mn of 25000 daltons or higher;
poly(isomannide-diglycolate), especially having a Mn of 16000 daltons or higher;
poly(isomannide-1,4-cyclohexanedicarboxylate), especially having a Mn of 27000 daltons or higher;
poly(isosorbide-co-1,4-cyclohexanedimethylene terephthalate) (PICT), especially having a Mn of 22000 daltons or higher, and/or especially having a glass transition temperature of 140° C. or higher;
poly(isosorbide-co-1,4-cyclohexanedimethylene furanoate) (PICF), especially having a Mn of 20000 daltons or higher, and/or especially having a glass transition temperature of 120° C. or higher;
poly(isosorbide succinate-co-terephthalate), preferably containing from 10 to 90 mole % of succinate (based on total dicarboxylic acid derived units), especially having a Mn of 16000 daltons or higher;
poly(isosorbide succinate-co-furanoate), preferably containing from 10 to 90 mole % succinate (based on total dicarboxylic acid derived units);
poly(isosorbide adipate-co-furanoate), preferably containing from 10 to 90 mole % adipate (based of total dicarboxylic acid derived units);
poly(isosorbide-co-1,3-propylene terephthalate) (PIPT), especially having a Mn of 16000 daltons or higher; and
poly(isosorbide-co-1,3-propylene furanoate) (PIPF), especially having a Mn of 16000 daltons or higher.

In particular preferred are polyester (co)polymers comprising monomer units derived from two different kinds of diols, especially the specific polyester (co)polymers listed herein above, comprising monomer units derived from said (bi)cyclic secondary diol (especially isosorbide) in 10-60 mole % (on the basis of total diol), particularly 20-55 mole %, especially 30-50 mole %. Especially preferred are polyester (co)polymers with a Mn of 22000 daltons or higher, selected from PI₁₀₋₆₀CT, PI₁₀₋₆₀CF, PI₁₀₋₆₀PT and PI₁₀₋₆₀PF, even more preferably selected from PI₃₀₋₅₀CT, PI₃₀₋₅₀CF, PI₃₀₋₅₀PT and PI₃₀₋₅₀PF.

The polyester (co)polymer obtained by or obtainable by the process of the invention can suitably be combined with additives and/or other (co)polymers and therefore the invention further provides a composition comprising said polyester (co)polymer and in addition one or more additives and/or one or more additional other (co)polymers.

Such composition can for example comprise, as additive, nucleating agents. These nucleating agents can be organic or inorganic in nature. Examples of nucleating agents are talc, calcium silicate, sodium benzoate, calcium titanate, boron nitride, zinc salts, porphyrins, chlorin and phlorin.

The composition according to the invention can also comprise, as additive, nanometric (i.e. having particles of a nanometric size) or non-nanometric and functionalized or non-functionalized fillers or fibres of organic or inorganic nature. They can be silicas, zeolites, glass fibres or beads, clays, mica, titanates, silicates, graphite, calcium carbonate, carbon nanotubes, wood fibres, carbon fibres, polymer fibres, proteins, cellulose fibres, lignocellulose fibres and nondestructured granular starch. These fillers or fibres can make it possible to improve the hardness, the stiffness or the permeability to water or to gases. The composition can comprise from 0.1% to 75% by weight, for example from 0.5% to 50% by weight, of fillers and/or fibres, with respect to the total weight of the composition. The composition can also be of composite type, that is to say can comprise large amounts of these fillers and/or fibres.

The composition can also comprise, as additive, opacifying agents, dyes and pigments. They can be chosen from cobalt acetate and the following compounds: HS-325 Sandoplast® Red BB, which is a compound carrying an azo functional group also known under the name Solvent Red 195, HS-510 Sandoplast® Blue 2B, which is an anthraquinone, Polysynthren® Blue R and Clariant® RSB Violet.

The composition can also comprise, as additive, a processing aid for reducing the pressure in the processing device. A mould-release agent, which makes it possible to reduce the adhesion to the equipment for shaping the polyester, such as the moulds or the rollers of calendering devices, can also be used. These agents can be selected from fatty acid esters and amides, metal salts, soaps, paraffins or hydrocarbon waxes. Specific examples of these agents are zinc stearate, calcium stearate, aluminium stearate, stearamide, erucamide, behenamide, beeswax or Candelilla wax.

The composition can also comprise other additives, such as stabilizers, etc. as mentioned herein above.

In addition, the composition can comprise one or more additional (co)polymers other than the one or more polyester (co)polymers according to the invention. Such additional (co)polymer(s) can suitably be chosen from the group consisting of polyamides, polystyrene, styrene copolymers, styrene/acrylonitrile copolymers, styrene/acrylonitrile/butadiene co-polymers, polymethyl methacrylates, acrylic copolymers, poly(ether/imide)s, polyphenylene oxides, such as poly(2,6-dimethylphenylene oxide), polyphenylene sulfide, poly-(ester/carbonate)s, polycarbonates, polysulphones, polysulphone ethers, polyetherketones and blends of these polymers.

The composition can also comprise, as additional (co)polymer, a polymer which makes it possible to improve the impact properties of the polymer, in particular functional polyolefins, such as functionalized polymers and copolymers of ethylene or propylene, core/shell copolymers or block copolymers.

The compositions according to the invention can also comprise, as additional (co)polymer(s), polymers of natural origin, such as starch, cellulose, chitosans, alginates, proteins, such as gluten, pea proteins, casein, collagen, gelatin or lignin, it being possible or not for these polymers of natural origin to be physically or chemically modified. The starch can be used in the destructured or plasticized form. In the latter case, the plasticizer can be water or a polyol, in particular glycerol, polyglycerol, isosorbide, sorbitans, sorbitol, mannitol or also urea. Use may in particular be made, in order to prepare the composition, of the process described in the document WO 2010/010282A1.

These compositions can suitably be manufactured by conventional methods for the conversion of thermoplastics. These conventional methods may comprise at least one stage of melt or softened blending of the polymers and one stage of recovery of the composition. Such blending can for example be carried out in internal blade or rotor mixers, an external mixer, or single-screw or co-rotating or counter-rotating twin-screw extruders. However, it is preferred to carry out this blending by extrusion, in particular by using a co-rotating extruder. The blending of the constituents of the composition can suitably be carried out at a temperature ranging from 220 to 300° C., preferably under an inert atmosphere. In the case of an extruder, the various constituents of the composition can suitably be introduced using introduction hoppers located along the extruder.

The invention also relates to an article comprising a polyester (co)polymer according to the invention or a composition comprising a polyester (co)polymer according to the invention and one or more additives and/or additional (co)polymers. The polyester (co)polymer may conveniently be used in the manufacturing of films, fibres, injection moulded parts and packaging materials, such as for example receptacles. The use of the polyester (co)polymer is especially advantageous where such films, fibres, injection moulded parts or packaging materials need to be heat-resistant or cold-resistant.

The article can also be a fibre for use in for example the textile industry. These fibres can be woven, in order to form fabrics, or also nonwoven.

The article can also be a film or a sheet. These films or sheets can be manufactured by calendering, cast film extrusion or film blowing extrusion techniques. These films can be used for the manufacture of labels or insulators.

This article can be a receptacle especially for use for hot filling and reuse applications. This article can be manufactured from the polyester (co)polymer or a composition comprising a polyester (co)polymer and one or more additives and/or additional polymers using conventional conversion techniques. The article can also be a receptacle for transporting gases, liquids and/or solids. The receptacles concerned may be baby's bottles, flasks, bottles, for example sparkling or still water bottles, juice bottles, soda bottles, carboys, alcoholic drink bottles, medicine bottles or bottles for cosmetic products, dishes, for example for ready-made meals or microwave dishes, or also lids. These receptacles can be of any size.

The article may for example be suitably manufactured by extrusion-blow moulding, thermoforming or injection-blow moulding.

The present invention therefore also conveniently provides a method for manufacturing an article, comprising the use of one or more polyester (co)polymers according to the invention and preferably comprising the following steps: 1) the provision of a polyester (co)polymer obtainable according to the process of this invention; 2) melting said polyester (co)polymer, and optionally one or more additives and/or one or more additional (co)polymers, to thereby produce a polymer melt; and 3) extrusion-blow moulding, thermoforming and/or injection-blow moulding the polymer melt into the article.

The article can also be manufactured according to a process comprising a stage of application of a layer of polyester in the molten state to a layer based on organic polymer, on metal or on adhesive composition in the solid state. This stage can be carried out by pressing, lamination, extrusion-lamination, coating or extrusion-coating.

The invention is further illustrated by the following non-limiting examples.

### EXAMPLES

### List of Abbreviations

CH₂Cl₂=dichloromethane
CD₂Cl₂=dideutero-dichloromethane (or also DCM-d2)
DSC=differential scanning calorimetry
EP=4-ethylphenol
FDCA=2,5-furandicarboxylic acid
GPC=gel permeation chromatography
HFIP=hexafluoro-2-propanol
IPA=isophthalic acid
ISO=isosorbide
MA=monohydric alcohol
MOP=4-methoxyphenol
4-MP=4-methylphenol (p-cresol)
Mn=number average molecular weight
Mw=weight average molecular weight
PDI=polydispersity index
PICF=poly(isosorbide-co-1,4-cyclohexanedimethylene-furanoate)
PICT=poly(isosorbide-co-1,4-cyclohexanedimethylene terephthalate)
PIPF=poly(isosorbide-co-1,3-propylene-furanoate)
PIPT=poly(isosorbide-co-1,3-propylene terephthalate)
PISA=poly(isosorbide succinate)
PISAT=poly(isosorbide succinate-co-terephthalate)
PMMA=poly(methyl methacrylate)
PS=polystyrene
TPA=terephthalic acid
TCE=1,1,2,2-tetrachloroethane
TCE-d2=1,2-dideutero-1,1,2,2-tetrachloroethane
Tg=glass transition temperature

### Analytical Methods:

In the below examples, the weight average molecular weight (Mw) and the number average molecular weight (Mn) have been determined by means of gel permeation chromatography (GPC), applying 2 different methods:

(1) For the samples in Examples 1-5 and Tables 1-5: GPC measurements were performed at 35° C. For the calculation PS standards were used as reference material. As eluent dichloromethane was used at a flowrate of 1 ml/min. The GPC measurements were carried out under these conditions on a 1260 Infinity II Refractive Index detector with a Agilent HPLC system equipped with two PLgel 5 μm MIXED-C (300×7.5 mm) columns. Calculation of the molecular weights was carried out with Agilent GPC/SEC software.

(2) For the samples in Examples 6-7 and Tables 6-7: GPC measurements were performed at 35° C. For the calculation PMMA standards were used as reference material. As eluent HFIP was used at 1 mL/min. The GPC measurements were carried out under these conditions on a Hitachi Chromaster 5450 with a Agilent HPLC system equipped with two PFG 7 micrometer (μm) Linear M (300×7.5 mm) columns. Calculation of the molecular weights was carried out with Astra 6 Software.

The glass transition temperature of the polyester polymers and copolymers in the below examples was determined using differential scanning calorimetry (DSC) with heating rate 10° C./minute in a nitrogen atmosphere. In the second heating cycle, a glass transition, (Tg), was recorded.

The content of the monomer units in the polyester polymers and copolymers of the below examples was determined by proton nuclear magnetic resonance (¹H NMR). The content of diol and diacid monomer units was determined using dideutero-dichloromethane (CD₂Cl₂), tetrachloroethane (TCE-d2) or dimethylsulfoxide-d6 as solvents, and dichloromethane (CH₂Cl₂), tetrachloroethane (TCE) or dimethylsulfoxide as a reference.

### Example 1

### Preparation of poly(isosorbide succinate) (PISA); at lab-scale, using 4-methylphenol

Succinic acid (7.085 g, 60 mmol), isosorbide (8.768 g, 60 mmol) and 4-methylphenol (9.732 g, 90 mmol) were weighed into a 100 ml three-neck flask. Butyltinoxide hydroxide hydrate (0.013 g, 0.06 mmol) was added as a suspension in 0.5 ml toluene. The flask was equipped with a nitrogen gas inlet, a top stirrer and a distillation head with a thermometer and a receiving flask attached to it. A constant nitrogen gas flow of 40 ml/min was maintained throughout the first step of the experiment (esterification). The reaction mixture was heated to 240° C. in a silicon oil bath. As soon as the oil bath temperature reached 150° C., stirring was initiated at a speed of 100 rpm. After 5 h at 240° C., the reactor was removed from the oil bath and was allowed to cool to room temperature under a nitrogen flow. Subsequently, the reactor was heated to 220° C. under a nitrogen flow of 40 ml/min. As soon as the oil bath temperature reached 150° C., stirring was initiated at 100 rpm. The second step of the experiment (polycondensation) was initiated when 220° C. oil bath temperature was reached. The nitrogen flow was turned off and a cold trap was connected to the receiving flask. A vacuum of 400 mbar was applied to the reactor and the pressure was halved every 15 minutes. After 105 minutes, full vacuum (between 0.3 and 0.9 mbar) was reached. After stirring the reaction for 60 min under full vacuum, the reactor was flushed with nitrogen. The distillation head and top stirrer were removed from the flask and the reaction product was scraped out of the reactor under a positive nitrogen flow.

Comparative examples were performed without a monohydric alcohol present and with an “unreactive” version, i.e. a compound not carrying reactive substituents.

The results are shown in Table 1.

TABLE 1
All experiments with summarized results in Table 1 were conducted
under identical reaction conditions. Comparative examples
are marked with an asterisk. Weight percentages are relative
to the total weight of monomers and/or oligomers.

| | Mₙ (GPC) | | T_{g} |
|---|---|---|---|
| Monohydric alcohol / other comparative | [kg/mol] | PDI | [° C.] |
| 4-methylphenol (61 weight %) | 40.4 | 2.4 | 82.2 |
| none* | 8.4 | 2.4 | 76.0 |
| “unreactive” | 10.2 | 2.0 | 77.6 |
| (1,4-dimethoxybenzene)* (78 weight %) | | | |
| “unreactive” | 10.2 | 2.0 | 77.6 |
| (diphenyl ether)* (97 weight %) | | | |

### Example 2

### Preparation of poly(isosorbide succinate), using 4-methylphenol, in 2 l autoclave

To prove the industrial viability of the method of Example 1, the synthesis of poly(isosorbide succinate) was scaled up from a 100 ml glass reactor to a 2 l stainless steel autoclave.

### Procedure

Isosorbide (453.0 g, 3.1 mol), succinic acid (366.1 g, 3.1 mol), 4-methylphenol (502.8 g, 4.65 mol), butyltin hydroxide oxide hydrate (0.647 g, 3.1 mmol) and tris(2,4-di-tert-butylphenyl)phosphite (0.351 g, 0.5 mmol) were weighed into a 2 l stainless steel autoclave. The reactor was closed and heated to 220° C. under a constant nitrogen flow. Stirring was initiated at a speed of 100 rpm when the oil temperature reached 150° C. After 1 h at 220° C., the oil temperature was increased to 240° C. This temperature was held for 5 h until no more water was collected in the receiving flask of the reactor. A melt sample of the reaction mixture was taken under a positive nitrogen flow to quantify the alcohol to ester end group ratio and the reactor was cooled to room temperature. Subsequently, 5.49 g of succinic acid were added to the reaction mixture and stirred for another 1.5 h at 240° C. Thereafter, the oil temperature was decreased to 220° C. and pre-polycondensation was initiated by slowly applying a vacuum of 400 mbar. The pressure in the reactor was halved (200, 100, 50, 25, 12.5 and 6.5 mbar) every 15 minutes until a pressure of 0.05-0.5 mbar was reached. After 1-1.5 hours at 0.05-0.5 mbar, polycondensation was complete. The reactor was flushed with nitrogen and a pressure of 2.3 bar was applied to the reactor. The polymer product was extruded through the bottom nozzle of the reactor into a water bath and chipped.

Results are summarized in Table 2.

TABLE 2

| Mₙ (GPC) [kg/mol] | M_{w} (GPC) [kg/mol] | PDI | T_{g} [° C.] |
|---|---|---|---|
| 35.3 | 78.5 | 2.2 | 80.4 |

### Example 3

### Preparation of PISA, using 2-methoxyphenol

Succinic acid (7.085 g, 60 mmol), isosorbide (8.768 g, 60 mmol), 2-methoxyphenol (11.173 g, 90 mmol) and tris(2,4-di-tert-butylphenyl)phosphite (6.8 mg, 0.01 mmol) were weighed into a 100 ml three-neck flask. Butyltinoxide hydroxide hydrate (0.013 g, 0.06 mmol) was added as a suspension in 0.5 ml toluene. The flask was equipped with a nitrogen gas inlet, a top stirrer and a distillation head with a thermometer and a receiving flask attached to it. The reactor was heated to 80° C. and four vacuum/nitrogen cycles were performed to deoxygenate the reaction mixture. A constant nitrogen gas flow of 40 ml/min was maintained throughout the first step of the experiment (esterification). The reaction mixture was heated to 240° C. in a silicon oil bath. As soon as the oil bath temperature reached 150° C., stirring was initiated at a speed of 100 rpm. After 5 h at 240° C., the reactor was removed from the oil bath and was allowed to cool to room temperature under a nitrogen flow. Subsequently, the reactor was reheated to 240° C. under a nitrogen flow of 40 ml/min. As soon as the oil bath temperature reached 150° C., stirring was initiated at 100 rpm. After another 4 h at 240° C., the reactor was removed from the oil bath and was allowed to cool to room temperature under a nitrogen flow. Next, the reactor was heated to 220° C. under a nitrogen flow and the second step of the experiment (polycondensation) was initiated. The nitrogen flow was turned off and a cold trap was connected to the receiving flask. A vacuum of 400 mbar was applied to the reactor and the pressure was halved every 15 minutes. After 105 minutes, full vacuum (between 0.3 and 0.9 mbar) was reached. After stirring the reaction for 90 min under full vacuum, the reactor was flushed with nitrogen. Under a positive nitrogen flow, the distillation head and top stirrer were removed from the flask and the reaction product was scraped out of the reactor. Results are summarized in Table 3.

TABLE 3

| Monohydric alcohol | Mₙ (GPC) [kg/mol] | PDI | T_{g} [° C.] |
|---|---|---|---|
| 2-methoxyphenol | 32.6 | 1.9 | 82.2 |

### Example 4

### Other Aliphatic Polyesters Containing Isosorbide, Using 4-Methylphenol

### Procedure for the Synthesis of Poly(Isosorbide Glutarate):

Glutaric acid (23.782 g, 180 mmol), isosorbide (26.305 g, 180 mmol), 4-methylphenol (29.195 g, 270 mmol) and butyltinoxide hydroxide hydrate (0.075 g, 0.36 mmol) were weighed into a 100 ml three-neck flask. The flask was equipped with a nitrogen gas inlet, a top stirrer and a distillation head with a thermometer and a receiving flask attached to it. A constant nitrogen gas flow of 40 ml/min was maintained throughout the first step of the experiment (esterification). The reaction mixture was heated to 240° C. in a silicon oil bath. As soon as the oil bath temperature reached 150° C., stirring was initiated at a speed of 100 rpm. After 6 h at 240° C., the reactor was removed from the oil bath and was allowed to cool to room temperature under a nitrogen flow. Subsequently, the reactor was reheated to 240° C. under a nitrogen flow of 40 ml/min. As soon as the oil bath temperature reached 150° C., stirring was initiated at 100 rpm. After 2 h at 240° C. (i.e. total esterification time 8 h), the oil bath temperature was decreased to 220° C. and the second step of the experiment (polycondensation) was initiated. The nitrogen flow was turned off and a cold trap was connected to the receiving flask. A vacuum of 400 mbar was applied to the reactor and the pressure was halved every 15 minutes. After 105 minutes, full vacuum (between 0.3 and 0.9 mbar) was reached. After stirring the reaction for 140 min under full vacuum, the reactor was flushed with nitrogen. The distillation head and top stirrer were removed from the flask and the reaction product was scraped out of the reactor under a positive nitrogen flow.

Additional experiments with different diacids (adipic acid, 1,4-cyclohexanedicarboxylic acid, diglycolic acid, thiodiglycolic acid, respectively) were also conducted on a 180 mmol scale (180 mmol of diacid, 180 mmol of diol and 270 mmol of 4-methylphenol in a 100 ml reactor). The specific conditions and results are summarized in Table 4.

TABLE 4

| | catalyst | Esterification | Poly- | | | |
|---|---|---|---|---|---|---|
| | [mol % respective | T [° C.]; | condensation | Mₙ (GPC) | | T_{g} |
| Polymer | to diacid] | t [h] | T [° C.]; t [min]^{a} | [kg/mol] | PDI | [° C.] |
| Poly(isosorbide | BuSnOOH [0.2] | 240; 8 | 220; 140 | 41.0 | 2.1 | 52.4 |
| glutarate) | | | | | | |
| Poly(isosorbide | BuSnOOH [0.2] | 240; 5 | 220; 240 | 29.4 | 2.1 | 34.6 |
| adipate)^{c} | | | | | | |
| Poly(isosorbide-1,4- | BuSnOOH [0.2] | 240-250; 12 | 240-260; 120 | 40.1 | 2.2 | 133.4 |
| cyclohexanedicarboxylate) | | | | | | |
| Poly(isosorbide | BuSnOOH [0.2] | 200-240; 6 | 200; 215 | 22.3 | 1.9 | 83.0 |
| diglycolate) | | | | | | |
| Poly(isosorbide | Ti(OBu)₄ [0.1]^{b} | 200-220; 8.5 | 200; 125 | 16.9 | 1.8 | 57.8 |
| thiodiglycolate)^{d} | | | | | | |

^{a}Reaction time at full vacuum (<1 mbar). Pre-polycondensation (slow pressure decrease from 400 mbar to <1 mbar, see Examples 1-3) conducted at temperature indicated for polycondensation
^{b}Catalyst added in two portions: before and after esterification.
^{c}A 2 mol % excess (respective to isosorbide) of adipic acid was used.
^{d}A 0.7 mol % excess (respective to isosorbide) of thiodiglycolic acid was used.

### Example 5

### Aliphatic Polyesters Containing Isomannide, Using 4-Methylphenol

The procedure of Example 4 was followed for polyesters prepared from isomannide and succinic acid, glutaric acid, adipic acid and diglycolic acid, respectively.

The specific conditions and results are summarized in Table 5.

TABLE 5

| | catalyst | Esterification | Polycondensation | | | |
|---|---|---|---|---|---|---|
| | [mol % resp. | T [° C.]; | T [° C.]; | Mₙ(GPC) | | T_{g} |
| Polymer | to diacid] | t [h] | t [min]^{a} | [kg/mol] | PDI | [° C.] |
| Poly(isomannide | BuSnOOH | 240; 5.5 | 220; 90 | 28.3^{b} | 2.8 | 82.3 |
| succinate) | [0.2] | | | | | |
| Poly(isomannide | BuSnOOH | 240; 8 | 220; 210 | 40.1 | 2.7 | 50.9 |
| glutarate) | [0.2] | | | | | |
| Poly(isomannide | BuSnOOH | 240; 7 | 220; 180 | 30.2 | 2.2 | 35.3 |
| adipate) | [0.2] | | | | | |
| Poly(isomannide | BuSnOOH | 200-240; 7 | 200-240; 210 | 20.4 | 2.0 | 79.8 |
| diglycolate) | [0.1] | | | | | |
| Poly(isomannide-1,4- | BuSnOOH | 240-250; 11 | 240-260; 145 | 32.6 | 2.4 | 133.5 |
| cyclohexanedicarboxylate) | [0.2] | | | | | |

^{a}Reaction time at full vacuum (<1 mbar). Pre-polycondensation (slow pressure decrease from 400 mbar to <1 mbar, see Examples 1-3) conducted at temperature indicated for polycondensation.
^{b}Polymer was melt quenched in liquid nitrogen to enable dissolution in DCM-d2.

### Example 6

### Preparation of poly(isosorbide-co-1,4-cyclohexanedimethylene) terephthalate (PICT), using 4 ethylphenol

In a 100 ml glass reactor, all the components were added before heating: 24.1 g of terephthalic acid as basis (1.0 equivalent, 145 mmol), 10.6 g of isosorbide (0.5 eq., 72.5 mmol), 10.4 g of 1,4-cyclohexanedimethanol (0.5 eq., 72.5 mmol), 21.2 g of 4-ethylphenol, 43 mg of catalyst (butyltin hydroxide oxide hydrate, 500 ppm). In a first phase, the reaction system was heated by an oil bath at 240° C. under nitrogen flow at 30 mL/min for 9.5 hours. Starting the second phase, the oil temperature was increased to 260° C. and the nitrogen flow was stopped, replaced by vacuum at 500 mbar. Step-wise, the vacuum was reduced and the solvent (4-ethylphenol) was collected in the distillation flask. As the polymer became more viscous, the temperature was increased step-wise, up to a maximum of 285° C. The torque registered by the mechanical stirrer increased as the polymer became more viscous, from 16 N·cm up to a maximum of 34 Ncm. The vacuum was slowly reduced for 2 hours, after which the system was kept below 1 mbar (down to 0.4 mbar) for 1 hour. The final polymer displays a Tg of 144.3° C., a weight-average molecular weight (Mw) of 60.4 kg/mol with light yellow color.

Results and conditions are shown in Table 6.

### Example 7

Other polyisosorbide-co-polyesters PICF, PIPT, PIPF and PISAT [poly(isosorbide-co-1,4-cyclohexanedimethylene furanoate), poly(isosorbide-co-1,3-propylene terephthalate), poly(isosorbide-co-1,3-propylene furanoate) and poly(isosorbide succinate-co-terephthalate), respectively] were synthesized in an analogous manner, with the differences summarized in Table 6. The reaction times for first and second phases were not kept constant. Instead, the reactions were followed by ¹H-NMR, visual aspects (homogeneity), water collection and torque progression (during polycondensation)—these techniques were used to determine when to finalize the two phases (nitrogen flow and vacuum).

Table 6. Parameters and results for the synthesis of PICT, PICF, PIPT, PIPF and PISAT polyesters. Comparative examples are marked with an asterisk.

TABLE 6

| | | | | | | Esterification/ |
|---|---|---|---|---|---|---|
| | | | | | | poly- |
| | | Feed | | | | condensation |
| Sample/MA | Diacid, | diacid/diols^{b} | Tg | Mn^{d} | | temperature^{e} |
| (wt %)^{a} | diols^{b} | (mol %) | (° C.)^{c} | (kg/mol) | PDI | (° C.) |
| PICT/EP | TPA | 100 | 144.3 | 26.2 | 2.3 | 240/260-285 |
| (47)^{1.2} | IS | 50 | | | | |
| | CHDM | 50 | | | | |
| PICT/MOP | TPA | 100 | 144.8 | 22.7 | 2.2 | 260/260-280 |
| (47)^{1.2} | IS | 53 | | | | |
| | CHDM | 50 | | | | |
| PICT/4-MP | TPA | 100 | 147.0 | 38.5 | 2.0 | 240/240-285 |
| (42)^{1.2} | IS | 50 | | | | |
| | CHDM | 50 | | | | |
| PICT* | TPA | 100 | 133.8 | 12.7 | 2.6 | 240-260/265-290 |
| | IS | 50 | | | | |
| | CHDM | 50 | | | | |
| PICT* | TPA | 100 | 138.6 | 14.6 | 2.5 | 260/260-280 |
| | IS | 53 | | | | |
| | CHDM | 50 | | | | |
| PICF/MOP | FDCA | 100 | 126.4 | 23.5 | 2.1 | 230/240-265 |
| (62)^{1.5} | IS | 50 | | | | |
| | CHDM | 50 | | | | |
| PICF/4-MP | FDCA | 100 | 128.7 | 37.0 | 1.9 | 230/240-275 |
| (42)^{1.2} | IS | 50 | | | | |
| | CHDM | 50 | | | | |
| PICF* | FDCA | 100 | 118.3 | 12.1 | 2.3 | 230/240-265 |
| | IS | 50 | | | | |
| | CHDM | 50 | | | | |
| PIPT/EP | TPA | 100 | 117.7 | 23.3 | 2.1 | 210-250/250-275 |
| (53)^{1.2} | IS | 50 | | | | |
| | PDO | 50 | | | | |
| PIPF/EP | FDCA | 100 | 114.9 | 22.2 | 2.2 | 220-230/240-285 |
| (46)^{1.0} | IS | 50 | | | | |
| | PDO | 50 | | | | |
| PISAT/4-MP | SA | 75 | 102.0 | 20.2 | 2.5 | 220-250/220-225 |
| (59)^{1.5} | TPA | 25 | | | | |
| | IS | 100 | | | | |

^{a}The weight percentage of the monohydric alcohol with regard to the total weight of monomers and/or oligomers, where used, is mentioned in brackets after the polymer’s name, and also the amount in equivalents relative to the diacid (1 eq.). is represented as superscript e.g. “PICT/EP(47)^{1.2}” refer to a reaction with isosorbide, CHDM and terephthalic acid using 47 weight % of 4-ethylphenol. The absence of a forward slash (/) and respective alcohol name means that no alcohol was used for that batch.
^{b}Feed composition relative to mols of diacid in the feed. PDO (“P”) = 1,3-propanediol; CDHM (“C”) = 1,4-cyclohexanedimethanol; TPA (“T”) = terephthalic acid; FDCA (“F”) = 2,5-furandicarboxylic acid; IS (“I”) = isosorbide; SA = succinic acid.
^{c}Glass transition temperature (T_{g}) determined by the midpoint from the second heating scan with DSC (dynamic scanning calorimetry), at 10° C./min.
^{d}Molecular weight measurements determined via GPC, using HFIP as solvent, with PMMA standards for all polyesters.
^{e}Temperature of the oil bath.

The preparation of PICT was studied in more detail with different monohydric alcohols, see Table 7. Catalyst: BuSnOOH, 0.14 mol % vs. TPA ^{a} The weight percentage of the monohydric alcohol with regard to the total weight of monomers and/or oligomers, where used, is mentioned in brackets after the polymer's name, and also the amount in equivalents relative to the diacid (1 eq.). is represented as superscript e.g. “PICT/EP(47)^{1 2}” refers to a reaction with isosorbide, CHDM and terephthalic acid using 47 weight % of 4-ethylphenol. The absence of a forward slash (/) and respective alcohol name means that no alcohol was used for that batch.^{b} Feed composition relative to mols of diacid in the feed. PDO (“P”)=1,3-propanediol; CHDM (“C”)=1,4-cyclohexanedimethanol; TPA (“T”)=terephthalic acid; FDCA (“F”)=2,5-furandicarboxylic acid; IS (“I”)=isosorbide; SA=succinic acid.^{c} Glass transition temperature (T_{g}) determined by the midpoint from the second heating scan with DSC (dynamic scanning calorimetry), at 10° C./min.^{d} Molecular weight measurements determined via GPC, using HFIP as solvent, with PMMA standards for all polyesters.^{e} Temperature of the oil bath.

TABLE 7

| | | | Poly- | | | | |
|---|---|---|---|---|---|---|---|
| | | Esterification | condensation | Mₙ | | | IS^{c} in |
| MA | BP^{b} | oil T [° C.]; | oil T [° C.]; | (GPC) | | T_{g} | polymer |
| (wt %.)^{a} | (° C.) | t [h] | t [min]^{a} | [kg/mol] | PDI | [° C.] | (mol %) |
| none | — | 260-270; 12 | 270-285; 2.8 | 13.7 | 2.4 | 135.8 | 46.5 |
| 4-ethylphenol | 218 | 240-250; 9.5 | 260-285; 2.3 | 26.2 | 2.3 | 144.3 | 50.1 |
| (53)^{1.2} | | | | | | | |
| 4-methoxyphenol | 243 | 260-265; 6.7 | 265-285; 2.5 | 24.0 | 2.3 | 141.6 | 50.0 |
| (55)^{1.4} | | | | | | | |
| 4-Cl-phenol | 220 | 240; 10.5 | 260-285; 2.5 | 24.7 | 2.8 | 144.6 | 49.9 |
| (49)^{1.2} | | | | | | | |
| 4-methylphenol | 202 | 240; 12 | 260-285; 2.3 | 27.9 | 2.3 | 145.1 | 50.0 |
| (51)^{1.5} | | | | | | | |

^{a}The weight percentage of the monohydric alcohol with regard to the total weight of monomers and/or oligomers, where used, is mentioned in brackets after the polymer's name, and also the amount in equivalents relative to the diacid (1 eq.). is represented as superscript.
^{b}boiling point of monohydric alcohol at ambient pressure
^{c}isosorbide derived monomer content in polymer end product, determined by ¹H-NMR.

1. A process for the chemical production of a polyester (co)polymer starting from monomers and/or oligomers, comprising reacting a mixture of at least
(a) one or more diol monomers, and
(b) one or more dicarboxylic acid monomers and/or esters thereof, and/or one or more oligomers comprising monomer units of (a) and (b);
wherein at least one diol monomer (a) is a secondary diol monomer; and
wherein in the process also is added
(c) a monohydric alcohol with a boiling point at ambient pressure of equal to or higher than 175° C. and an acid dissociation constant determined at 25° C. in water of equal to or less than 12.0 and equal to or more than 7.0, in an amount of 2.5-100 weight % with regard to the total weight of monomers and/or oligomers.

2. The process of claim 1, wherein at least one secondary diol (a) is/are selected from cyclic or bicyclic secondary diols, and in particular from 1,4:3,6-dianhydrohexitols, cis- and/or trans-2,2,4,4-tetramethyl-1,3-cyclobutanediol, especially from 1,4:3,6-dianhydrohexitols, and preferably one secondary diol is isosorbide.

3. The process of claim 1, wherein the one or more dicarboxylic acid monomers and/or esters thereof (b) is/are selected from (hetero)aromatic dicarboxylic acids, and from C2-C18 aliphatic dicarboxylic acids which may be linear, cyclic or branched, and/or monoesters and/or diesters thereof.

4. The process of claim 3, wherein the one or more dicarboxylic acid monomers and/or esters thereof (b) is/are selected from terephthalic acid, a terephthalic acid monoester, a terephthalic acid diester, a furandicarboxylic acid, a furandicarboxylic acid monoester, and a furandicarboxylic acid diester.

5. The process of claim 4, wherein, in addition to the secondary diol monomers (a), at least one further diol is added, selected from C2-C18 aliphatic diols, in particular from linear, cyclic or branched, saturated C2-C12 aliphatic diol compounds, and preferably from ethylene glycol, 1,3-propanediol, 1,4-butanediol, 1,5-pentanediol, 1,6 hexanediol, diethyleneglycol, neopentylglycol, 1,4-cyclohexanedimethanol, and acetals of polyols, especially acetals of C6 polyols, and particularly 2,3:4,5-di-O-methylene-galactitol, 2,4:3,5-di-O-methylene-D-mannitol, 2,4:3,5-di-O-methylene-D-glucitol, 2,3:4,5-di-O-isopropylidene-galactitol, 2,4:3,5-di-O-isopropylidene-D-mannitol and 2,4:3,5-di-O-isopropylidene-D-glucitol.

6. The process of claim 3, wherein the one or more dicarboxylic acid monomers and/or esters thereof (b) is/are selected from aliphatic dicarboxylic acids, preferably from 1,4-cyclohexanedicarboxylic acid, diglycolic acid, and linear dicarboxylic acids of the formula HOOC(CH2)nCOOH wherein n is an integer of 0 to 20.

7. The process of claim 1, wherein the alcohol (c) is an optionally substituted phenol, in particular selected from phenol, 4-methylphenol, 4 ethylphenol, 2 methoxy-phenol, 4-methoxyphenol, 4-ethyl-2-methoxyphenol, 4-chlorophenol, and any combination thereof.

8. The process of claim 1, wherein the total amount of the monohydric alcohol (c) is added at the start of the reaction.

9. The process of claim 1, wherein some of the alcohol (c) is added to the process as from the start of the process and, in addition, more of the alcohol (c) is continuously supplied to the reaction mixture during the process.

10. A polyester (co)polymer obtainable by a process according to claim 1, in particular having a number average molecular weight Mn of 15000 daltons or more, as measured by gel permeation chromatography, using poly(methyl methacrylate) or polystyrene standards as reference material, and using hexafluoro-2-propanol or dichloromethane, respectively, as eluent, wherein the combination of poly(methyl methacrylate) with hexafluoro-2-propanol is used when aromatic diacid or heteroaromatic diacid derived monomer units are present in the (co)polymer, and the combination polystyrene and dichloromethane is used when aliphatic diacid monomer units are present in the (co)polymer, and having a polydispersity index of from equal to or higher than 1.8 to equal to or lower than 2.8, more particular to equal to or lower than 2.6, and containing of repeating units selected from one or more of isosorbide-succinate, isosorbide-glutarate, isosorbide-adipate, isosorbide-diglycolate, isosorbide-thiodiglycolate, isosorbide-1,4-cyclohexane¬dicarboxylate, isomannide-succinate, isomannide-glutarate, isomannide-adipate, isomannide-diglycolate, isomannide-thiodiglycolate, isomannide-1,4-cyclohexane-dicarboxylate, isosorbide co-1,4-cyclohexane¬dimethylene furanoate, isosorbide-co-1,3-propylene terephthalate, isosorbide-co¬-1,3-propylene furanoate and isosorbide succinate-co-terephthalate, and a polyester (co)polymer having a number average molecular weight Mn, as measured by gel permeation chromatography, of 22000 daltons or more, containing repeating units of isosorbide co-1,4-cyclohexanedimethylene terephthalate.

11. The polyester of claim 10, selected from a polyester (co)polymer comprising total dicarboxylic acid-derived monomer units and total diol-derived monomer units in a 1:1 ratio, selected from
poly(isosorbide succinate);
poly(isosorbide-glutarate);
poly(isosorbide-adipate);
poly(isosorbide-diglycolate);
poly(isosorbide-thiodiglycolate);
poly(isosorbide-1,4-cyclohexane-dicarboxylate);
poly(isomannide-succinate);
poly(isomannide-glutarate);
poly(isomannide-adipate);
poly(isomannide-diglycolate);
poly(isomannide-1,4-cyclohexanedicarboxylate);
poly(isosorbide co-1,4-cyclohexanedimethylene terephthalate);
poly(isosorbide co-1,4-cyclohexanedimethylene furanoate);
poly(isosorbide succinate-co-terephthalate);
poly(isosorbide succinate-co-furanoate);
poly(isosorbide adipate-co-furanoate);
poly(isosorbide-co-1,3-propylene terephthalate); and
poly(isosorbide-co-1,3-propylene furanoate).

12. A polyester (co)polymer obtained by a process according to claim 1, in particular having a number average molecular weight Mn of 15000 daltons or more, as measured by gel permeation chromatography using poly(methyl methacrylate) or polystyrene standards as reference material, and using hexafluoro-2-propanol or dichloromethane, respectively, as eluent, wherein the combination of poly(methyl methacrylate) with hexafluoro-2-propanol is used when aromatic diacid or heteroaromatic diacid derived monomer units are present in the (co)polymer, and the combination polystyrene and dichloromethane is used when aliphatic diacid monomer units are present in the (co)polymer, having a polydispersity index of from equal to or higher than 1.8 to equal to or lower than 2.8.

13. The polyester (co)polymer according to claim 12, containing repeating units selected from one or more of isosorbide-succinate, isosorbide-glutarate, isosorbide-adipate, isosorbide-diglycolate, isosorbide-thiodiglycolate, isosorbide-1,4-cyclohexane-dicarboxylate, isomannide-succinate, isomannide-glutarate, isomannide-adipate, isomannide-diglycolate, isomannide-thiodiglycolate, isomannide-1,4-cyclohexane¬dicarboxylate, isosorbide co-1,4-cyclohexanedimethylene terephthalate, isosorbide co-1,4-cyclohexane-dimethylene furanoate, isosorbide-co-1,3-propylene terephthalate, isosorbide-co-1,3-propylene furanoate and isosorbide succinate-co-terephthalate.

14. The polyester (co)polymer of claim 12, selected from a polyester (co)polymer comprising total dicarboxylic acid-derived monomer units and total diol-derived monomer units in a 1:1 ratio, selected from
poly(isosorbide succinate);
poly(isosorbide-glutarate);
poly(isosorbide-adipate);
poly(isosorbide-diglycolate);
poly(isosorbide-thiodiglycolate);
poly(isosorbide-1,4-cyclohexane-dicarboxylate);
poly(isomannide-succinate);
poly(isomannide-glutarate);
poly(isomannide-adipate);
poly(isomannide-diglycolate);
poly(isomannide-1,4-cyclohexanedicarboxylate);
poly(isosorbide co-1,4-cyclohexanedimethylene terephthalate);
poly(isosorbide co-1,4-cyclohexanedimethylene furanoate);
poly(isosorbide succinate-co-terephthalate);
poly(isosorbide succinate-co-furanoate);
poly(isosorbide adipate-co-furanoate);
poly(isosorbide-co-1,3-propylene terephthalate); and
poly(isosorbide-co-1,3-propylene furanoate).

15. A composition comprising the polyester (co)polymer of claim 10, and in addition one or more additives and/or one or more additional other (co)polymers.
